(19) United States
(12) Patent Application Publication
(10) Pub. No.: US 2014/0295973 A1
(43) Pub. Date: Oct. 2, 2014

(54) SERVER DEVICE, AND NON-TRANSITORY COMPUTER-READABLE STORAGE MEDIUM STORING GAME PROGRAM

(71) Applicant: DeNA Co., Ltd., Tokyo (JP)

(72) Inventors: Masatoshi INAGAWA, Tokyo (JP); Takashi NINJOUJI, Tokyo (JP); Eri AIKAWA, Tokyo (JP); Ayaka WATANABE, Tokyo (JP); Takahiro EZAKI, Tokyo (JP); Ryo YAMASAKI, Tokyo (JP); Yoshikazu ODA, Tokyo (JP)

(73) Assignee: DeNA Co., Ltd., Tokyo (JP)

(21) Appl. No.: 14/070,335

(22) Filed: Nov. 1, 2013

(30) Foreign Application Priority Data
Mar. 26, 2013 (JP) 2013-064710

(51) Int. Cl. A63F 13/30

(52) U.S. Cl. CPC A63F 13/12
USPC 463/42

(57) ABSTRACT

In a combat type game using a network, an interchange between players is promoted. A server device that controls a game played by a player using game media in a game space through a network includes a storage unit that stores information about the game media owned by the player in the game space and about states of the game media; a medium transferring unit that transfers the game media from the player owning the game media such that the game media are owned by another player; a determining unit that determines whether a specific game medium among the game media has satisfied a predetermined transfer requirement; and a changing unit that changes, when it is determined that the specific game medium has satisfied the predetermined transfer requirement, the specific game medium from a first state to a second state and stores the changed state in the storage unit.

### BACKGROUND OF THE INVENTION

1. Field of the Invention

The present invention relates to a server device and a game program.

2. Description of the Related Art

There is a game in which players (characters controlled by the players) do combat with each other using a game medium such as cards (e.g., JP 2001-239056 A). In particular, a network combat game is widely spread in which a plurality of players can participate in the game through a network.

### SUMMARY OF THE INVENTION

A game using a network can be made active with a larger number of players participating in the game. To do so, it is desirable that an interchange between players be performed actively in the game. For a means used when players perform an interchange therebetween in a network combat game such as that described above, there is a method of promoting an interchange between players by the players communicating with each other by exchanging a game medium (cards) with each other or giving gifts to each other. However, in the conventional network combat game, there is a case in which an exchange of a game medium and the like is not sufficiently performed, and thus, an interchange between players cannot be sufficiently promoted.

The present invention is made in view of such circumstances, and an object of the present invention is therefore to promote an interchange between players in a combat type game using a network.

The main aspect of the present invention to solve the above-described problem is directed to a server device that controls a game played by a player using game media in a game space through a network, the server device including: a storage unit that stores information about the game media owned by the player in the game space and about states of the game media; a medium transferring unit that transfers the game media from the player owning the game media such that the game media are owned by another player; a determining unit that determines whether a specific game medium among the game media has satisfied a predetermined transfer requirement; and a changing unit that changes, when it is determined that the specific game medium has satisfied the predetermined transfer requirement, the specific game medium from a first state to a second state and stores the changed state in the storage unit.

Other characteristics of the present invention will become clear from the description of the present specification and the appended drawings.

According to the present invention, in a combat type game using a network, an interchange between players can be promoted.

### BRIEF DESCRIPTION OF THE DRAWINGS

FIG. 1 is a diagram illustrating an example of an overall configuration of a game system 1 according to the present embodiment.

FIG. 2 is a block diagram illustrating a functional configuration of the server device 10 according to the present embodiment.

FIG. 3 is a block diagram illustrating a functional configuration of a player terminal 20 according to the present embodiment.

FIG. 4 is a diagram illustrating an example of a game card character introduction screen displayed on a terminal display unit 24.

FIG. 5 is a diagram illustrating an exemplary data structure of card information stored in a data storage unit 12 of the server device 10.

FIG. 6 is a diagram illustrating an exemplary data structure of cards owned by a player among player information stored in the data storage unit 12 of the server device 10.

FIG. 7 is a flowchart for describing a change in the state of a mystery card.

FIG. 8 is a diagram illustrating a specific example for when a mystery card changes from a first state to a second state.

FIG. 9 is a diagram illustrating an exemplary data structure of cards owned by a player in a second embodiment.

FIG. 10 is a diagram illustrating an example of a mystery card owning players' history display screen displayed on a terminal display unit 24 in the second embodiment.

### DETAILED DESCRIPTION OF THE INVENTION

At least the following matters will become clear according to the description of the present specification and the appended drawings.

A server device that controls a game played by a player using game media in a game space through a network, the server device being characterized by including: a storage unit that stores information about the game media owned by the player in the game space and about states of the game media; a medium transferring unit that transfers the game media from the player owning the game media such that the game media are owned by another player; a determining unit that determines whether a specific game medium among the game media has satisfied a predetermined transfer requirement; and a changing unit that changes, when it is determined that the specific game medium has satisfied the predetermined transfer requirement, the specific game medium from a first state to a second state and stores the changed state in the storage unit.

According to such a server device, in a combat type game using a network, an interchange between players can be promoted.

In addition, in the server device, the predetermined transfer requirement may be that the specific game medium be transferred a predetermined number of times or more.

According to such a server device, to change a specific card (a mystery card which will be described later) to the second state, the specific card needs to be transferred the predetermined number of times or more. Thus, to perform a transfer, a player owning the card gets to actively perform an interchange with another player, and thus, an interchange between players is promoted.

In addition, in the server device, the predetermined transfer requirement may be that the specific game medium has been owned by a predetermined number or more of players having different player IDs, by transferring the specific game medium.

According to such a server device, to change a mystery card to the second state, the mystery card needs to be transferred among a plurality of players. Thus, a player owning the card gets to actively perform an interchange with more players, and thus, an interchange between players is promoted.

In addition, in the server device, the storage unit may store, for each specific game medium, a player having owned the specific game medium, and a screen displaying, on the specific game medium, a list of the player having owned the specific game medium may be created, or a screen displaying a list of the player having owned the specific game medium, together with the specific game medium may be created.

According to such a server device, by displaying names and the like on a mystery card, the displayed players gain prestige, enabling to give the players a feeling of satisfaction. In addition, by recording the footprints of the owning players, the mystery card itself is added with a value as an antique, increasing the rarity value of the mystery card.

In addition, in the server device, the changing unit may determine a parameter in the second state of the specific game medium, based on a parameter set for the specific game medium in the first state and a parameter of the player having owned the specific game medium.

According to such a server device, the value of a mystery card changes depending on what players the mystery card has been transferred through. Thus, in order to gain a mystery card with a high value, a player gets to actively communicate with another player, and thus, an interchange between players is further promoted.

In addition, in the server device, the game media may be set with levels, and when a level of the specific game medium is lower than a predetermined level, even if there is a request from a player owning the specific game medium, the medium transferring unit may not transfer the specific game medium to another player.

According to such a server device, since it becomes difficult to satisfy the transfer requirement, it becomes difficult to change a mystery card from the first state to the second state. Accordingly, the mystery card in the second state becomes more valuable.

In addition, there is disclosed a non-transitory computer-readable storage medium storing a game program that causes an information processing device to realize a game played by a player using game media in a game space through a network, and that causes the information processing device to realize the functions of: storing, by a storage unit, information about the game media owned by the player in the game space and about states of the game media; transferring, by a medium transferring unit, the game media from the player owning the game media such that the game media are owned by another player; determining, by a determining unit, whether a specific game medium among the game media has satisfied a predetermined transfer requirement; and when it is determined that the specific game medium has satisfied the predetermined transfer requirement, changing, by a changing unit, the specific game medium from a first state to a second state and storing the changed state in the storage unit.

### EMBODIMENTS

### Configuration of Game System 1

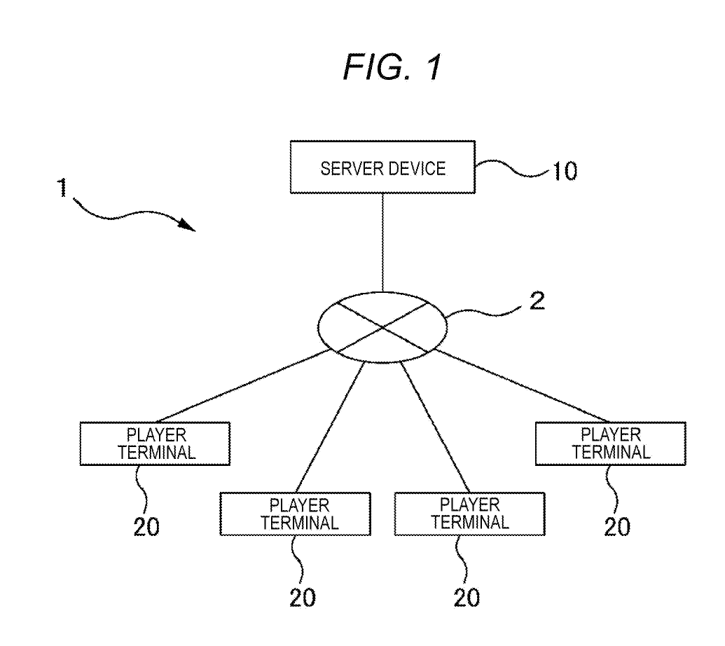

FIG. 1 is a diagram illustrating an example of an overall configuration of a game system 1 according to the present embodiment.

The game system 1 provides users (hereinafter, also called “players”) with various types of services regarding games (social games and the like) through a network 2. The game system 1 is configured to include a server device 10 and a plurality of player terminals 20 which are connected to the network 2 in a communicable manner.

A player can play a game transmitted through the network 2 by accessing the game system 1 from a player terminal 20. In addition, the player can communicate with a plurality of other players by accessing the game system 1.

### <Server Device 10>

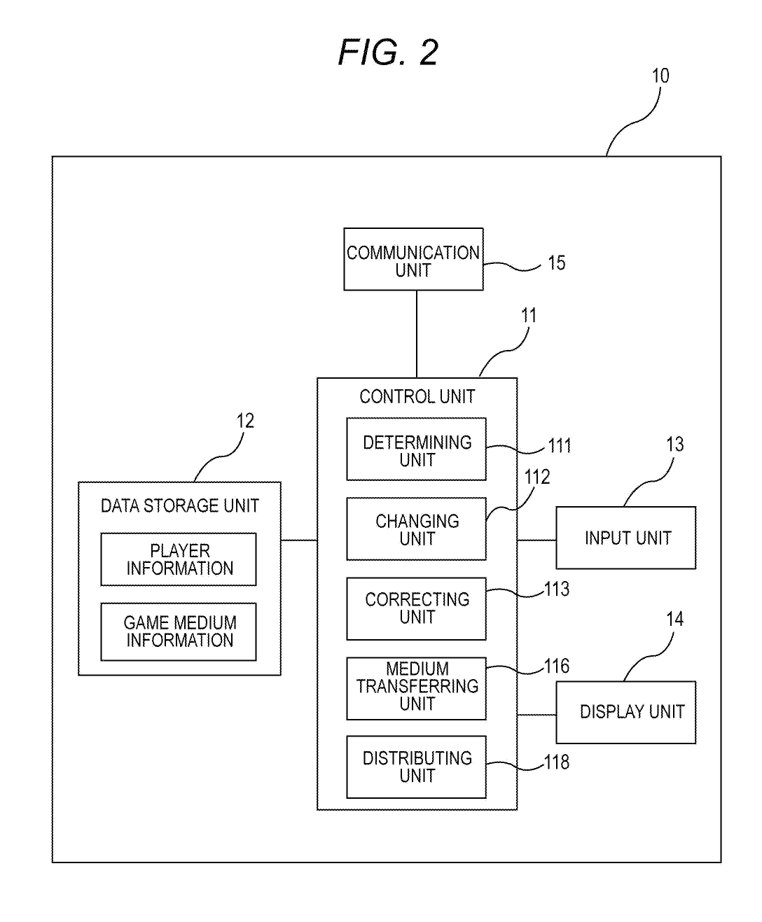

FIG. 2 is a block diagram illustrating a functional configuration of a server device 10. The server device 10 is an information processing device (for example, a workstation, a personal computer, and the like) used when a system administrator and the like manage the game service. The server device 10 can distribute a game program operable on the player terminal 20, and a web page made in a markup language (HTML, and the like) according to a specification of the player terminal 20 upon receiving various commands (requests) from the player terminal 20. The server device 10 of the present embodiment includes a control unit 11, a data storage unit 12, an input unit 13, a display unit 14, and a communication unit 15.

The control unit 11 performs data passing among the units and controls the entire server device 10. The control unit 11 includes a determining unit 111, a changing unit 112, a correcting unit 113, a medium transferring unit 116, and a distributing unit 118. Specific operation of each unit will be described later.

The data storage unit 12 includes a read only memory (ROM) that is a read only storage area in which a system program is stored, and a random access memory (RAM) that is a rewritable storage area used as a work area for arithmetic processing by the control unit 11. The storage unit 12 is, for example, realized by a non-volatile storage device, such as a flash memory or a hard disk. The data storage unit 12 of the present embodiment stores information about game media (e.g., game cards) and items which are used during a game. In addition, the data storage unit 12 stores player information which is information about the strengths of the respective players and about game media owned by the players during a game, and the like. The data structure of the information stored in the data storage unit 12 will be described later.

The input unit 13 is used by the system administrator and the like to input various types of data and settings for a game (e.g., the settings of mystery cards which will be described later, and the like). The input unit 13 is realized by, for example, a keyboard, a mouse, and the like.

The display unit 14 is used for displaying an operation screen for the system administrator based on a command from the control unit 11, and is, for example, realized by a liquid crystal display (LCD) and the like.

The communication unit 15 is used to perform communication with the player terminals 20. The communication unit 15 has a function serving as a receiving unit that receives various types of data and signals transmitted from the player terminals 20, and a function serving as a transmitting unit that transmits various types of data and signals to the player terminals 20 in response to commands from the control unit 11. The communication unit 15 is, for example, realized by a network interface card (NIC), and the like.

### <Player Terminal 20>

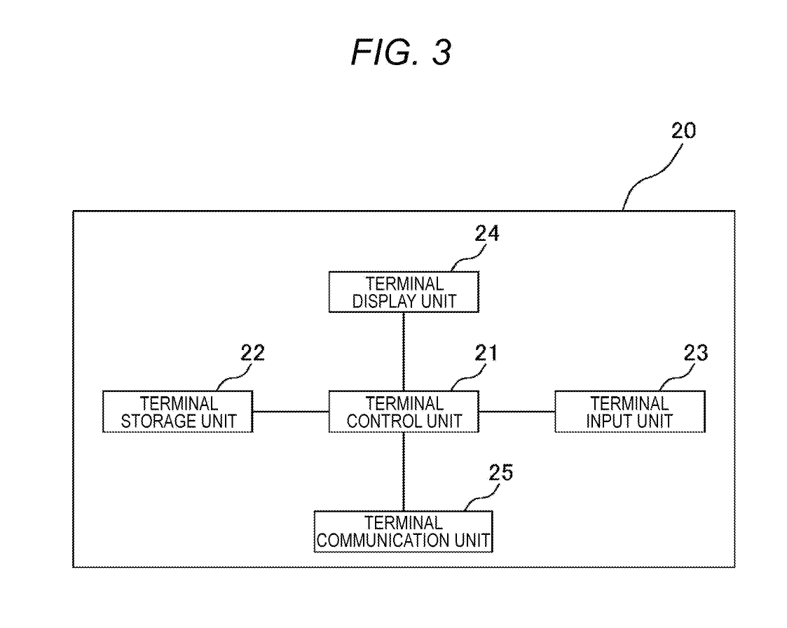

FIG. 3 is a block diagram illustrating a functional configuration of the player terminal 20. The player terminal 20 is an information processing terminal operated by a player (user) when playing a game. The player terminal 20 is, for example, a mobile phone terminal, a smartphone, a personal computer, a game machine, and the like, and transmits and receives information to/from the server device 10 accessible through the network 2. The player terminal 20 according to the present embodiment includes a terminal control unit 21, a terminal storage unit 22, a terminal input unit 23, a terminal display unit 24, and a terminal communication unit 25.

The terminal control unit 21 performs data passing among units and controls the entire player terminal 20, and is realized by the central processing unit (CPU) executing a program stored in a predetermined memory. Note that the terminal control unit 21 of the present embodiment also functions as a screen display control unit that controls a display form of the game screen displayed in the terminal display unit 24.

The terminal storage unit 22 is connected to the terminal control unit 21 through a bus, and performs processing of referring to, reading out, rewriting stored data according to a command from the terminal control unit 21. The terminal storage unit 22 is realized, for example, by a flash memory, a hard disk, and the like.

The terminal input unit 23 is used by the player to perform various types of operation (game operation, text input operation, and the like). The terminal input unit 23 is realized by, for example, operation buttons, a touch panel, and the like.

The terminal display unit 24 is used to display game screens which are created based on game information and in response to commands from the terminal control unit 21. The terminal display unit 24 is realized by, for example, a liquid crystal display (LCD) and the like.

The terminal communication unit 25 is used to perform communication with the server device 10, and has a function serving as a receiving unit that receives various types of data and signals transmitted from the server device 10, and a function serving as a transmitting unit that transmits various types of data and signals to the server device 10 in response to commands from the terminal control unit 21. The terminal communication unit 25 is, for example, realized by a network interface card (NIC), and the like.

### ===Outline of Game===

An outline of a game provided by the game system 1 will be described. The game system 1 of the present embodiment can provide a player (user) with a combat game which is played using game media. In the following, a combat type card game played using game cards which is an example of the game media will be described. Note that the game cards are digital content game cards and thus are virtual cards used in the virtual space of the game.

### <Combat Type Card Game>

The game system 1 according to the present embodiment can provide a combat type card game in which a character selected by a player is allowed to fight against a character controlled by another player who is an opponent or by a computer through the network 2, by which winning or losing is determined

In the combat type card game, first, the player selects a character to do combat. In the present embodiment, the player can own a plurality of game cards (virtual cards used in the virtual space of the game), and the game cards are associated with game characters, respectively. Hence, when the player selects one or a plurality of game cards for use in the combat from among the plurality of game cards owned thereby, a character associated with the selected game card is set as a character for doing the combat (combat game medium). In addition, each game card (a character associated with the game card) is set with a level. The values of parameters (e.g., attack power, defense power, physical strength, and the like) set for the game card increase according to an increase in level. Therefore, the player can allow the combat to progress advantageously by collecting game cards with high levels.

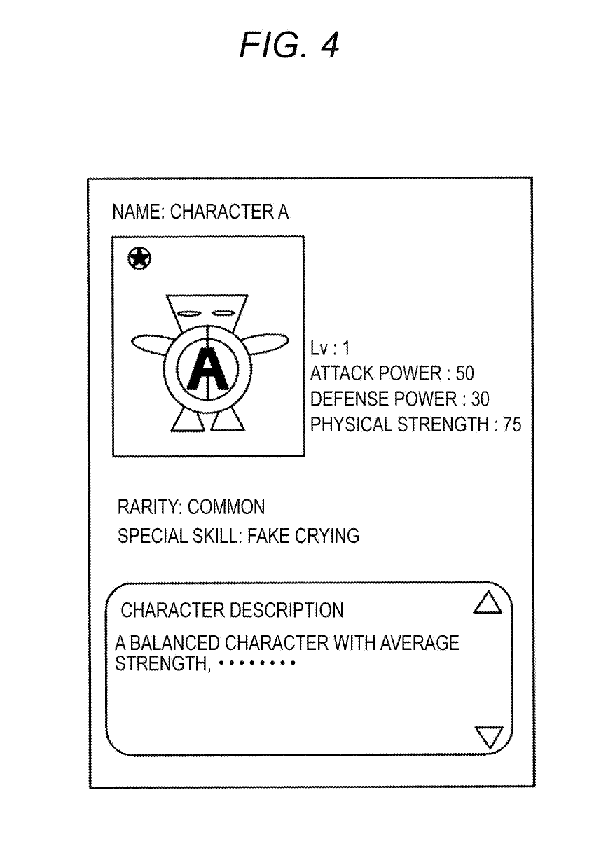

FIG. 4 is a diagram illustrating an example of a game card character introduction screen displayed on the terminal display unit 24. As illustrated in FIG. 4, a graphic of a character associated with a game card and information such as a level (Lv) of the character, various types of parameters for the level, and description of the character are displayed. The player can check information about the strength of the game card (character) by viewing a screen such as that in FIG. 4.

The player does combat with a combat game medium of another player or the computer, using his/her combat game medium (one or a plurality of selected game cards). Winning or losing of the combat is determined based on the magnitudes of parameters set for the combat game media of both the player and the opponent. For example, if, as a result of a comparison of the attack power of the combat game medium of the player with the defense power of the combat game medium of the opponent, the attack power of the combat game medium of the player is higher than the defense power of the combat game medium of the opponent, then the result is a player's win. On the other hand, if the attack power of the combat game medium of the player is less than or equal to the defense power of the combat game medium of the opponent, then the result is a player's loss. Note that the method of determining winning or losing of the combat is not limited thereto, and a method may be used in which a player having given greater damage to the other is a winner or in which a player who is the first one to have brought the physical strength of the other to zero is a winner. In addition, the parameters of the combat game medium may change according to the level or parameters (attack power, defense power, and the like) of the player him/herself. For example, it may be configured such that the higher the attack power of a player owning a combat game medium, the higher the attack power of the combat game medium.

When the player wins the combat, he/she can gain experience points, in-game currency, an item, and the like, as the reward for the win. By collecting them, the player can allow the game to progress more advantageously. For example, by increasing the level of the player him/herself or the level of a game card owned by the player by accumulating experience points, or by purchasing a more powerful item by using in-game currency, it helps the player to win the combat.

### <Flow of Game>

Next, the overall flow of the game will be described.

A game (social game) provided in the present embodiment progresses by a player doing missions. The “missions” refer to assignments and duties given to the player during the game, and are called in different ways depending on the game, e.g., “quests” and “searches”. When a mission is performed, the player gets in-game currency or an item, or combat with an enemy takes place. Every time they are performed, the accomplishment rate of the mission increases. When the accomplishment rate reaches 100%, the mission is considered cleared, allowing the player to select a new mission. The player can allow the game to progress by accomplishing missions one by one which are given one after another. In addition, it is also possible that the player freely does combat (battle) with other players independently of a mission. By the player winning the combat, he/she can obtain the reward for the win.

Each player is set with information such as experience points, possessed money (in-game currency possessed by the player), and action points, as parameters. The parameters change according to the progress of the game. For example, when the player performs a certain mission, his/her experience points or possessed money increases as a result of the mission.

In addition, in the game of the present embodiment, the player can participate in an in-game event (hereinafter, also simply referred to as an “event”). The “event” refers to an activity held in the game during a certain fixed period (e.g., one week from Sunday to Saturday). By performing missions taking place in the event to allow players to compete against each other for their points such as experience points gained during the event period or for the number of wins of combats during the event period, a ranking of the players in the event is determined. Then, the players are awarded prizes according to the ranking in the event. The prizes include in-game currency, an item, a game card, and the like. In particular, higher-ranking winners in the event are awarded limited cards and the like which are only available as those prizes. Since such limited cards have high rarity (rarity value) and have powerful parameters, many players get to actively participate in the event to acquire the limited cards. This can make the game active. Note that the player does not necessarily need to participate in the event and can perform normal missions during the event holding period.

### <For Transfer of Game Card>

The game of the present embodiment is aimed at doing combat and the like between players through the network 2. Thus, the larger the number of players participating in the game becomes, the more fun the game becomes, making the game more likely to become active. To increase the number of players participating in the game, it is desirable to make an interchange between players on the network 2 active.

For a means of performing an interchange between players on the network 2, a game card may be transferred between players. As used herein, the transfer of a game card refers to a change of the ownership of a game card owned by a certain player to another player. Note that the types of transfer include a “trade” in which players exchange their game cards, items, in-game currency, and the like, with each other, a “gift” in which a player transfers his/her game card to another player for free, and the like, and they are collectively called the “transfer” in this specification.

However, a transfer of a game card performed in the actual game is likely to be limited between friend players (friend players in the game) or between some players, and a frequent transfer is not really performed. Hence, in the conventional network combat game, an interchange between players has not been able to be sufficiently promoted.

In view of this, in the game of the present embodiment, a “mystery card” is provided as a game medium for promoting an interchange between players by increasing the number of opportunities to transfer game cards between players. The “mystery card” is a game card that changes from a first state to a second state by satisfying a predetermined requirement. A mystery card is distributed to a player in the first state. In other words, at the point in time when the player has gained a mystery card, the mystery card is in the first state. At this stage, the second state of the mystery card has not been disclosed to the player. That is, it is a game card whose state after a change is unknown (mystery). In the present embodiment, with a requirement (transfer requirement) that a mystery card in the first state has been transferred between players a predetermined number of times or more, the mystery card changes to the second state.

The parameters of a mystery card in the first state are set to very low values. Therefore, the mystery card in this state is not likely to become a force at combat. Thus, there is not much advantage in players owning the mystery card in the first state. On the other hand, when the mystery card changes to the second state by satisfying the predetermined requirement, the parameters set for the mystery card in the first state dramatically increase, by which the mystery card changes to a powerful game card. Even if a player having gained a mystery card in the first state owns the mystery card in the first state as it is, there is no effective way to use the mystery card. Thus, the player gets to actively transfer the card in order to change it to the second state, rather than owning the card as it is. By this, an interchange between players is promoted.

Note that as with normal game cards, the levels of mystery cards can also be increased. Specific details of mystery cards will be described later.

### <<Data Configuration>>

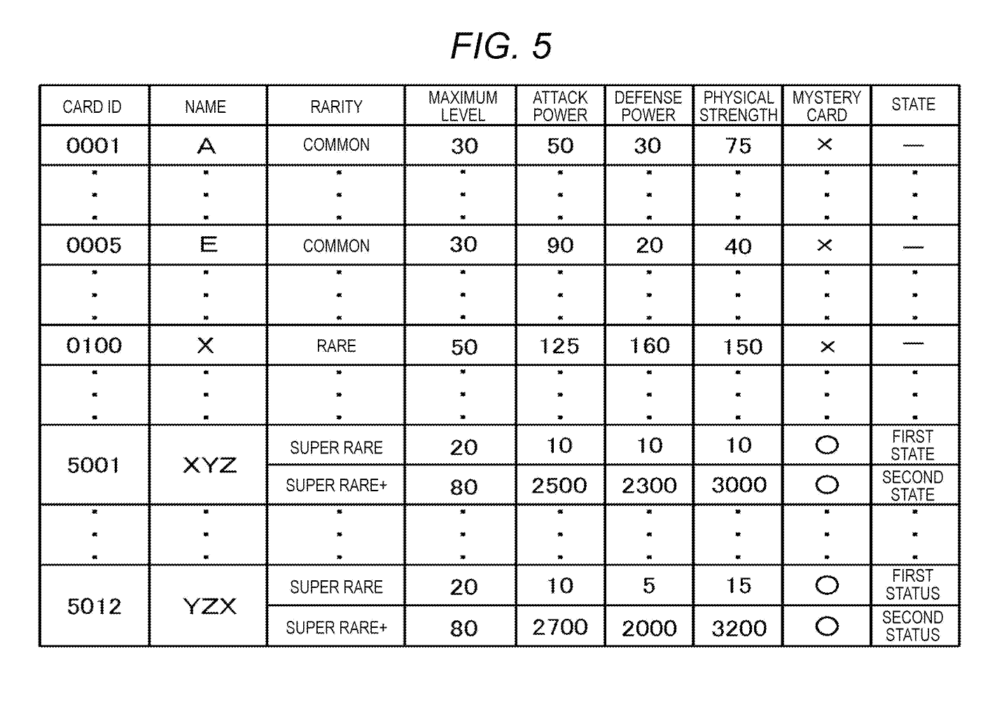

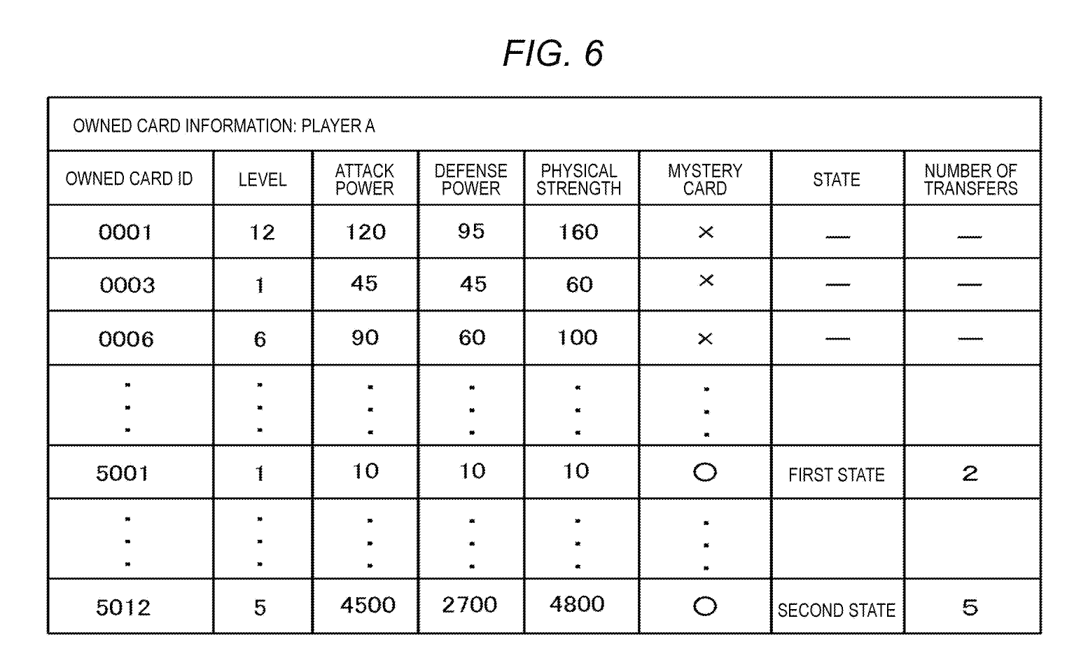

Next, the data configuration in the game of the present embodiment will be described. The data storage unit 12 of the server device 10 stores various types of information such as information about game cards and game items which serve as game media, and player information. Various types of information used in the game system 1 of the present embodiment will be described. FIG. 5 is a diagram illustrating an exemplary data structure of card information. FIG. 6 is a diagram illustrating an exemplary data structure of cards owned by a player among player information.

### <Card Information>

Card information is configured to include a card ID which is an example of identification information identifying a game card; and various types of information about the game card associated with the card ID. For example, as illustrated in FIG. 5, card information includes information indicating a card ID, a character associated with a game card, the maximum level of the character, various types of parameters (initial parameters) of the character at the initial level such as attack power, defense power, and physical strength, and information indicating whether the game card is a mystery card. In addition to those pieces of information, information such as the rarity (rarity value) of the game card and skills (a special skill and a special ability) exercised at combat may be provided.

When a game card is a mystery card, maximum levels and initial parameters are set for the respective states of the mystery card. For example, in FIG. 5, the mystery card represented by card ID: 5001 is set with initial parameters for the first state and initial parameters for the second state.

### <Player Information>

Among player information, owned card information is information indicating a game card owned by each player (hereinafter, also referred to as an owned card). A player's owned card has parameters unique thereto, and the parameters are stored in the data storage unit 12 so as to be associated with the ID of the game card. For example, as illustrated in FIG. 6, owned card information includes an owned card ID, a level of a character associated with the game card, and various types of parameters such as attack power, defense power, and physical strength for the level. Various types of parameters such as attack power may be calculated from the initial parameters of the game card recorded as card information (see FIG. 5) and the level of the game card at the present time.

Note that when a transfer of a game card is performed, the medium transferring unit 116 removes information on the game card which is the transfer target from owned card information of a player on the transferring side. Then, information on the game card which is the transfer target is added and stored in owned card information of a player on the transferred side.

Furthermore, the owned card information of the present embodiment includes information indicating whether the owned game card is a mystery card, information indicating the state of the game card when the game card is a mystery card, and information indicating the number of transfers. As described above, since a mystery card changes its state based on the predetermined transfer requirement, information indicating the state of the mystery card at the present time and information indicating how many times the memory card has been transferred up to the present time are stored. Every time a mystery card is transferred by the medium transferring unit 116, information indicating the number of transfers is stored so as to be associated with the mystery card which is the transfer target. For example, FIG. 6 illustrates that the mystery card with card ID: 5001 has been transferred twice up to the present time.

Various types of parameters of a mystery card are determined based on the state (the first state or the second state) and level of the card at the present time. For example, in FIG. 6, the mystery card with card ID: 5001 owned by player A has level 1 of the first state. The parameters of the mystery card in this state are determined by referring to the initial parameters in the first state of the mystery card with card ID: 5001 in FIG. 5. In FIG. 6, the mystery card with card ID: 5012 has level 5 of the second state. The parameters of the mystery card in this state are determined by referring to the initial parameters in the second state of the mystery card with card ID: 5012 in FIG. 5, and based on the level (level 5) at the present time. For a method of determining parameters at a level at the present time, for example, there is a method in which points according the level are added to initial parameters, or in which initial parameters are multiplied by a coefficient according to the level.

Note that information about mystery cards may be managed independently of information about normal game cards. For example, card information dedicated to mystery cards (not shown) is held separately from card information (database) such as that illustrated in FIG. 5. Then, the parameters in the respective states (the first state and the second state) of the mystery cards may be managed by the card information dedicated to mystery cards.

For player information, in addition to owned card information, information about a player ID, player's experience points, a player's level, items and in-game currency owned by the player, and the like, is stored.

### ===Specific Description of Mystery Card===

Usage of mystery cards in the game system 1 will be described using a specific example.

### <Method of Gaining Mystery Card>

First, a method of gaining a mystery card by a player will be described. Game cards (game media) including mystery cards used in the present embodiment are distributed to players by the distributing unit 118 of the server device 10. A game card is distributed in response to a request from a player using a distributing means generally called “gacha”, or is distributed to a player as a prize for a mission or an event. “Gacha” is known and thus description thereof is omitted.

In the present embodiment, mystery cards are not distributed to all players playing the game, but mystery cards are distributed on a priority basis to players having satisfied the predetermined requirement during the game. For example, mystery cards are distributed on a priority basis to players who are the top 100 prize winners in a certain event. The distributing unit 118 extracts the player IDs of the players who are the top prize winners in the event and who are the distribution targets, and then adds and stores information on the mystery cards in the first state in owned card information among player information of the players (see FIG. 6).

Note that instead of directly distributing a mystery card to a player, the mystery card may be indirectly distributed to the player by giving the player a right to participate in gacha which gives the chance to gain a mystery card, and the like. In this case, the player given the right to participate in gacha can gain a mystery card by playing gacha. By allowing the player to gain a mystery card by gacha, the player's sense of anticipation for gaining a mystery card can be increased, and the player can be given a feeling of satisfaction for acquiring a valuable game card with his/her own hands.

### <Change in State of Mystery Card>

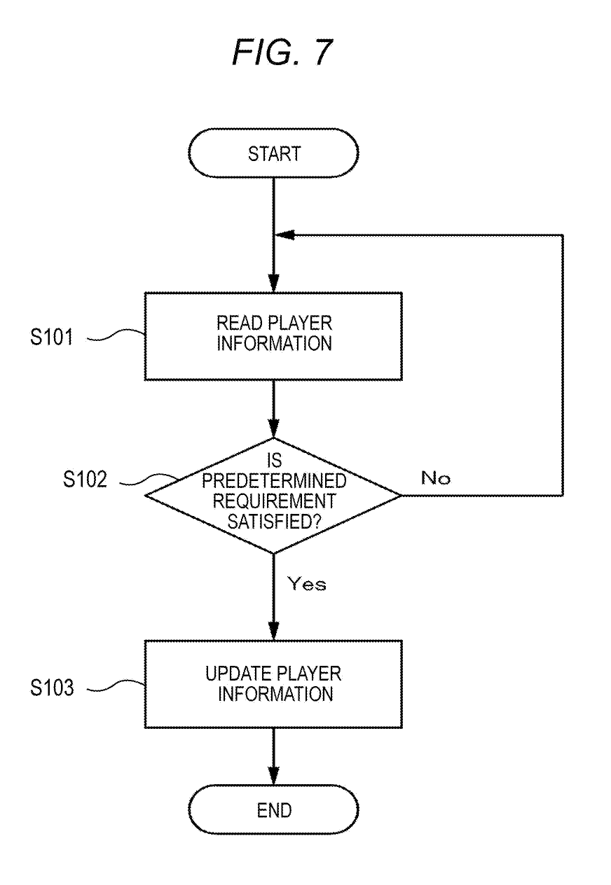

Next, a change in the state of a mystery card will be described. As described above, a mystery card is in the first state at the point in time when the mystery card is distributed to a player, and changes to the second state by satisfying the predetermined requirement (transfer requirement). FIG. 7 is a flowchart for describing a change in the state of a mystery card.

First, to determine the state of a mystery card, the determining unit 111 of the server device 10 accesses player information of a player (player A) owning the mystery card and game medium information to read information about the mystery card (S101). In the case of a data structure such as that illustrated in FIG. 6, it is determined whether the player A owns the mystery card. If the player A owns the mystery card, data about the state (first state) of the card is read.

Then, it is determined whether the mystery card satisfies the predetermined transfer requirement (S102). In the present embodiment, the predetermined transfer requirement is the number of transfers. That is, it is determined whether the mystery card in the first state has been transferred between players a predetermined number of times or more. For example, when the mystery card changes to the second state with 5 transfers, it is determined whether the number of transfers at the present time is greater than or equal to 5 or less than 5.

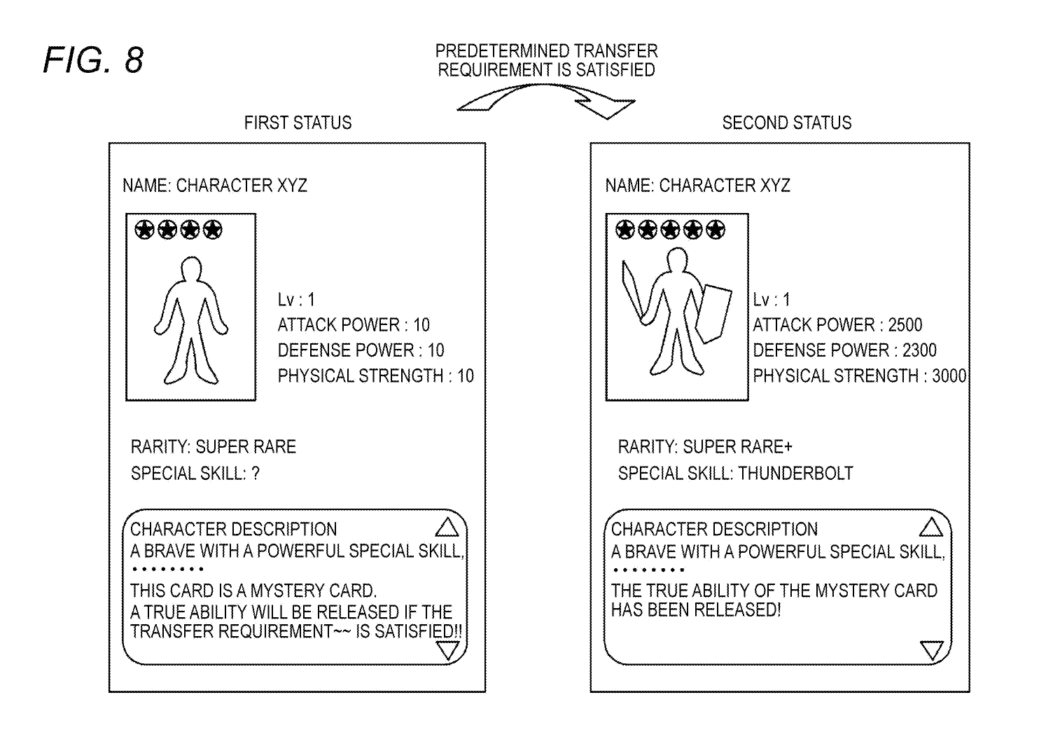

The determining unit 111 determines whether the mystery card satisfies the predetermined transfer requirement. If it is determined that the mystery card satisfies the transfer requirement (Yes at S102), the changing unit 112 of the server device 10 updates the player information of the player A to change information indicating the state of the mystery card from the first state to the second state (S103). FIG. 8 is a diagram illustrating a specific example for when a mystery card changes from the first state to the second state. FIG. 8 illustrates examples of a mystery card introduction screen displayed on a terminal display unit 24 of a player terminal 20.

As illustrated on a screen on the left in FIG. 8, in the first state, the mystery card has parameters set to low values. In addition, in the first state, the mystery card is insufficient as a force at combat, e.g., a special skill (special ability) cannot be used. It may be configured such that when the mystery card is in the first state, part or all information about the mystery card is not disclosed to the player. For example, in addition to the aforementioned special skill, a graphic of a character of the mystery card may not be displayed. In this case, the player cannot know what character his/her mystery card is associated with, and thus, has difficulty guessing the second state of the mystery card. However, by making description indicating that the mystery card changes to the second state by satisfying the predetermined transfer requirement and indicating the second state (a true ability after the change) in mystery card description (character description field in FIG. 8), player's imagination can be stimulated. By this, in order to change the mystery card to the second state, the player gets to actively contribute to a transfer of the mystery card.

Then, as illustrated on a screen on the right in FIG. 8, after the mystery card has changed to the second state by satisfying the predetermined transfer requirement, the values of various types of parameters significantly increase compared to those in the first state, and thus, the mystery card becomes a great force as a combat game medium. In addition to the increase in various types of parameters, the graphic of the character changes and a special skill (special ability) becomes available, by which the player can realize that the true ability of the mystery card has been released.

If it is determined that the mystery card does not satisfy the predetermined transfer requirement (No at S102), the state of the mystery card is not changed and processing returns to the process at S101.

As such, in the game of the present embodiment, a mystery card is provided that changes from the first state to the second state by satisfying the predetermined requirement (transfer requirement). Even if a player owns a mystery card in the first state, there is no effective way to use the mystery card, and thus, he/she attempts to actively transfer the mystery card to another player. By this, an interchange between players on the network 2 can be promoted.

### <Other Effects of Mystery Card>

Although, as an effect brought about when a mystery card changes from the first state to the second state, an increase in parameters and the like are described, other effects may be provided. For example, the mystery card is allowed to exert a special effect during a predetermined period such as a period during which an event is held. As used herein, the special effect refers to the effect of correcting parameters set for the mystery card at combat. In this case, the correcting unit 113 of the server device 10 performs the process of correcting the parameters of the mystery card in the second state to a predetermined magnitude (e.g., a magnitude three times that of a normal one) during the event holding period. Since the mystery card is further strengthened, a player owning the mystery card can allow the game to progress more advantageously.

In addition, as another effect, there may be provided the effect of correcting, when a mystery card is combined with another game card during an event period, the combining efficiency to 10 times that of a normal one. For example, in the case in which 100 experience points can be obtained when game cards are combined using a normal game card as a material, 1000 experience points can be obtained by combining game cards using a mystery card as a material.

### Second Embodiment

In a second embodiment, when a mystery card is transferred between players, information on players having owned the mystery card is displayed as a history.

### <For Display of History Information>

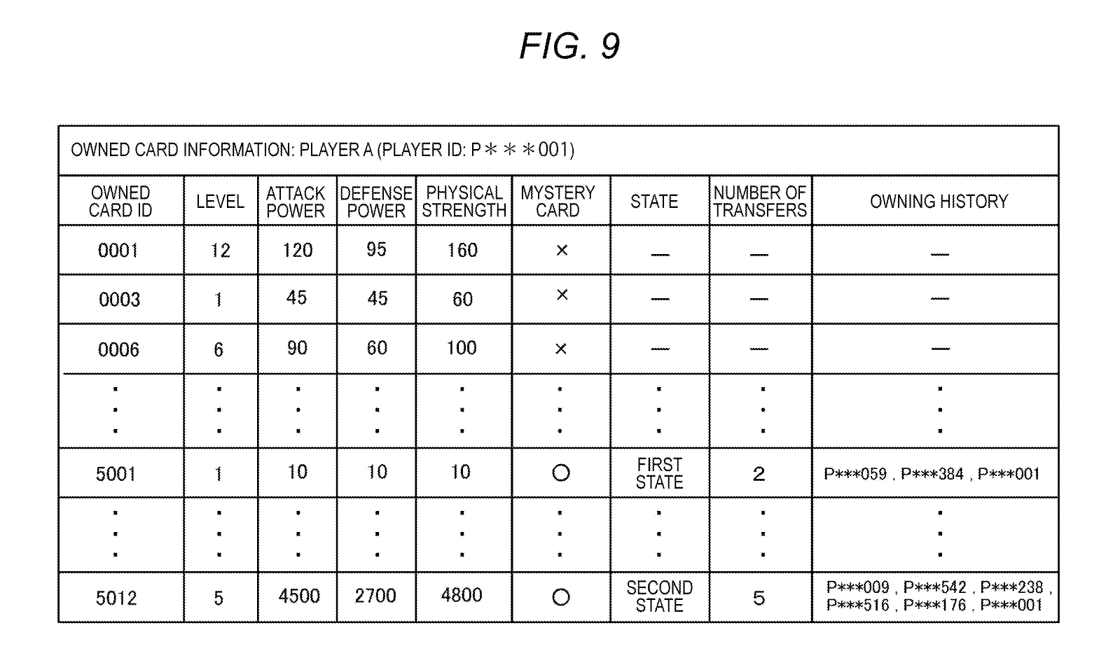

FIG. 9 is a diagram illustrating an exemplary data structure of cards owned by a player in the second embodiment. In the second embodiment, when a game card owned by a player is a mystery card, owning history information about the mystery card is included in addition to each data illustrated in FIG. 6. The owning history information is ID information of players having owned the mystery card. Every time a player owning a mystery card is changed by transferring the mystery card by a medium transferring unit 116, the ID of a new owning player is added to owning history information and stored in a data storage unit 12 in turn. For example, in FIG. 9, the mystery card with card ID: 5001 indicates that the mystery card has been owned by three players, player B (player ID: P***059), player C (player ID: P***384), and player A (player ID: P***001) who is the current owner, up to the present time in the course of two transfers.

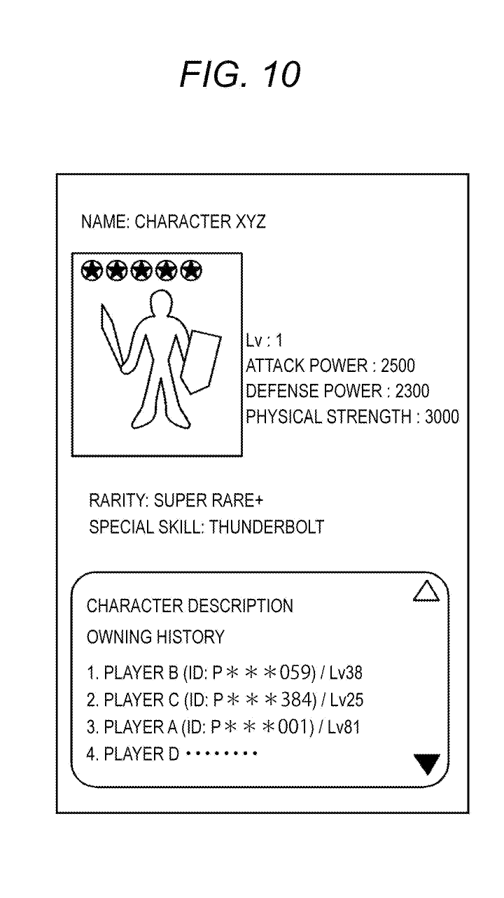

Based on this owning history information, a history of owning players is displayed on a mystery card introduction screen. FIG. 10 is a diagram illustrating an example of a mystery card owning players' history display screen displayed on a terminal display unit 24 in the second embodiment. In the drawing, on an introduction screen of a mystery card in the second state (a character description field in FIG. 10), a list of previous players having owned the mystery card is displayed. Information to be displayed includes the names and levels of the owning players, the order of the players owning the mystery card, and the like. Information on each player is referred to and displayed in association with a player ID which is stored as owning history information. In addition, the avatar images, event results, and the like, of the players may be displayed.

By displaying a list of owning players, a player can check from which player to which player the mystery card has been taken over. By displaying names and the like on a mystery card which has a high rarity value and which is powerful (in the second state), the displayed players gain prestige, enabling to give the players a feeling of satisfaction. For example, the name of a player whose name is displayed on many types of mystery cards gets more opportunities to be seen by other players. Accordingly, the player becomes famous on the network 2 or gets more opportunities to be praised by other players.

In addition, by recording the footprints of the owning players, the mystery card itself is added with a value as an antique. By this, the rarity value of the mystery card further increases.

### <Exemplary Use of History Information>

By displaying a history on a mystery card, the transfer requirement for when the mystery card changes from the first state to the second state can be managed more strictly. For example, when the “number of transfers” is set as the transfer requirement, a transfer needs to be performed a predetermined number of times or more. Here, when only the “number of transfers” is used as the requirement, by performing a transfer from a certain player to a different player, it is counted as one transfer on data. In this case, even by two players repeating a transfer therebetween, the number of transfers reaches the predetermined number of times. Thus, there is a possibility that the transfer requirement may be met easily. On the other hand, as in the present embodiment, by managing owning history information, in addition to the number of transfers, the number of players transferred can be used as the requirement. When the number of players transferred is used as the requirement, the number of players having owned the mystery card needs to be a predetermined number or more. That is, the requirement is that the mystery card be owned by a plurality of players having different player IDs.

In the second embodiment, a determining unit 111 refers to owned card information of a player (S101 in FIG. 7) to determine whether predetermined types of player IDs are stored in owning history information of the mystery card (S102 in FIG. 7). For example, when the requirement is that at least five transfers have been performed among different players, it is determined whether six or more types of player IDs are stored in the history information. Then, if it is determined that the transfer requirement is satisfied (Yes at S102 in FIG. 7), a changing unit 112 changes the mystery card to the second state (S103 in FIG. 7). On the other hand, if it is determined that the transfer requirement is not satisfied (No at S102 in FIG. 7), the state of the mystery card is not changed.

In an embodiment such as that described above, since there is a need to transfer a mystery card among a plurality of players, any action that circumvents rules can be prevented, e.g., the transfer requirement is cleared by two players repeating a transfer of a mystery card therebetween again and again. In addition, each player gets to more enthusiastically contribute to the distribution of a mystery card and thus an interchange between players is promoted.

It may be configured such that the parameters of a mystery card in the second state are influenced by the parameters of players having owned the mystery card in the first state. Specifically, the changing unit 112 determines, based on the parameters set for a mystery card in the first state and the parameters of players having owned the mystery card, the parameters in the second state of the mystery card. For example, in the case in which a mystery card in the first state has a history that the mystery card has been owned by five players A to E, when the mystery card changes to the second state, the parameters (attack power, physical strength, and the like) of the mystery card in the second state are determined using a coefficient based on the levels and parameters of the players A to E.

By this, owning history information of a mystery card becomes more important. For example, the strength of a mystery card in the second state differs between when the mystery card is owned by a player having high parameters and when the mystery card is owned by a player having low parameters. When a mystery card is transferred between players having high parameters, the parameters of the mystery card in the second state are high. On the other hand, when a mystery card is transferred between players having low parameters, the parameters of the mystery card in the second state are low. That is, the value of a mystery card changes depending on what players the mystery card has been transferred through. In order to gain a mystery card with a high value, a player gets to actively communicate with another player, and thus, an interchange between players is promoted.

### Other Embodiments

The above-described embodiments have been given for easy understanding of the present invention, and are not used to construe the present invention in a limited manner. Needless to say, the present invention may be changed or modified without departing from the spirit and scope thereof and the present invention includes equivalency thereof. In addition, embodiments described below are also included in the present invention.

### <For Limitation on Transfer of Game Card>

Although in the above-described embodiments no particular limitations are imposed when a player transfers a game card to another player, a limitation may be imposed upon a transfer of a game card. For example, only when a game card which is the transfer target has a predetermined level or more, its transfer is allowed. In particular, in the case of a game card being a mystery card, when the level of the mystery card is lower than a predetermined level, even if there is a request from a player owning the mystery card, the medium transferring unit 116 does not transfer the mystery card to another player.

In addition, the level of a mystery card required upon a transfer may increase in a stepwise manner, according to the number of transfers. For example, it is configured such that a player who is the first owner of a mystery card can transfer the mystery card even if the mystery card is in the state of level 1, but a player who is the second owner cannot transfer the mystery card unless the mystery card reaches level 5 or more, and a player who is the third owner cannot transfer the mystery card unless the mystery card reaches level 10 or more. By this, since a player having received a mystery card needs to increase the level of the mystery card by making a certain amount of effort and then transfer the mystery card, the mystery card in the second state becomes more valuable. In addition, an item or a ticket for performing a transfer may be provided, and a transfer may be allowed only when a player possesses the item and the like. When a transfer of a mystery card is limited, it becomes difficult to satisfy the transfer requirement. Thus, a mystery card in the second state becomes more valuable.

In addition, a player having transferred a mystery card may be given a reward such as in-game currency, an item, or a game card. By this, a transfer of a mystery card can be promoted.

### <For Change in State of Mystery Card>

Although in the above-described embodiments an example is described in which a mystery card changes from the first state to the second state by satisfying the predetermined requirement, the change in the state of the mystery card is not limited thereto. For example, it may be configured such that a mystery card having changed to the second state changes to a third state by further satisfying an additional requirement.

In addition, when a mystery card changes from the first state to the second state, the mystery card is not necessarily strengthened, but the parameters may change to decrease. Namely, there may be a mystery card that is weakened. Note, however, that in this case the distribution condition should be eased, e.g., mystery cards are distributed to all players for free, instead of being distributed as prizes for higher-ranking winners in an event.

### <Display of Mystery Card Owning History>

It may be configured such that my page screen (not shown) of each player displays how many mystery cards the player has owned and transferred up until now, so that other players can browse the my page screen. At that time, the numbers of transfers and the like may be displayed such that the mystery cards are ranked according to their rarities, parameters, and the like. Likewise, a ranking may be provided according to the number of cards transferred, and the like.

By this, a player can show off his/her contribution level to the distribution of mystery cards, to other players through his/her “my page”, and thus, gets to more enthusiastically contribute to a transfer of mystery cards.

### <For Combat Using Mystery Card>

When a player does combat with another player using a mystery card in the second state as a combat game medium, the parameters of the mystery card may change based on owning history information described in the second embodiment. For example, it is assumed that player A does combat with player B. At this time, when the player B is recorded in owning history information of a mystery card owned by the player A, the correcting unit 113 performs a correction process in which the parameters of the mystery card such as attack power are reduced at a predetermined rate (e.g., the parameters are reduced by 50% of those at normal times). Alternatively, in the combat with the player B, the player A may not be allowed to use the mystery card.

In contrast, it is assumed that the player A does combat with an enemy character in cooperation with the player B. At this time, when the player B is recorded in owning history information of a mystery card owned by the player A, the correcting unit 113 performs a correction process in which the parameters of the mystery card such as attack power is increased at a predetermined rate (e.g., the parameters are increased by 50% of those at normal times). Alternatively, when the player A fights jointly with the player B, the mystery card may exercise a special ability (e.g., the enemy character is made unable to take action for a fixed period of time).

That is, since the player B is a former owner of the mystery card and thus is a player having contributed to bringing the mystery card to the second state, an effect that makes the player B advantageous in combat is added.

### <For Mystery Card Data Management>

In the above-described embodiments, when data such as parameters about mystery cards is managed, a database of a structure such as that illustrated in FIG. 5 or 6 is used, but the method of managing mystery card data is not limited thereto.

For the method of managing mystery card data, a mystery card in the first state and a mystery card in the second state may be treated as different independent cards. For example, the mystery card with card ID: 5001 in FIG. 5 is managed as different cards, card ID: 5001A and card ID: 5001B, instead of being managed in data format representing the “state”, the first state or the second state. That is, the mystery cards are managed separately such that the card with card ID: 5001A corresponds to a mystery card (XYZ) in the first state, and the card with card ID: 5001B corresponds to the mystery card (XYZ) in the second state. In this case, relation information indicating that the card with card ID: 5001B corresponds to the second state of the card with card ID: 5001A (information indicating the relation between the cards) is held, by which the different game cards are managed so as to be associated with each other. By this, a change in the state of a mystery card can be reproduced.

In addition, when the predetermined transfer requirement is satisfied, among owned card information of a player, information on a mystery card in the first state may be overwritten with information on the mystery card in the second state. For example, in FIG. 5, for the mystery card with ID: 5001, at first, only data in the first state (e.g., various types of parameters) is set, and when the predetermined transfer requirement is satisfied, the data in the first state is overwritten with data in the second state. In this case, by overwriting the data, the data in the first state is discarded. With such a management method, data representing the “states” of mystery cards does not need to be managed and thus the amount of data held can be reduced.

### <Information Processing Device>

Although in the above-described embodiments description is made using, as an example, the game system 1 including one server device 10 as an example of an information processing device, the game system 1 is not limited thereto and may include a plurality of server devices 10 as information processing devices. That is, a plurality of server devices 10 is connected through a network 2, and each of the server devices 10 may perform various types of processing in a distributed manner.

Further, it may be configured such that the player terminal 20 bares a part of the functions as the information processing device. In this case, the server device 10 and the player terminal 20 constitute the information processing device.

### <Game Program>

In the game system 1 in the above-described embodiments, an example is described in which by allowing the server device 10 and a player terminal 20 to operate in cooperation with each other, a combat type card game using game media such as mystery cards is played. The present invention also includes a game program for performing those processes. Specifically, the server device 10 serving as an information processing device and a player terminal 20 may perform the above-described processes based on the game program.

### FIG. 1

10 SERVER DEVICE
20 PLAYER TERMINAL

### FIG. 2

15 COMMUNICATION UNIT
12 DATA STORAGE UNIT
PLAYER INFORMATION
GAME MEDIUM INFORMATION
11 CONTROL UNIT
111 DETERMINING UNIT
112 CHANGING UNIT
113 CORRECTING UNIT
116 MEDIUM TRANSFERRING UNIT
118 DISTRIBUTING UNIT
14 DISPLAY UNIT
13 INPUT UNIT

### FIG. 3

22 TERMINAL STORAGE UNIT
24 TERMINAL DISPLAY UNIT
21 TERMINAL CONTROL UNIT
25 TERMINAL COMMUNICATION UNIT
23 TERMINAL INPUT UNIT

### FIG. 4

NAME: CHARACTER A
ATTACK POWER
DEFENSE POWER
PHYSICAL STRENGTH
RARITY: COMMON
SPECIAL SKILL: FAKE CRYING
CHARACTER DESCRIPTION
A BALANCED CHARACTER WITH AVERAGE STRENGTH, . . .

### FIG. 5

CARD ID
NAME
RARITY
COMMON
RARE
SUPER RARE
SUPER RARE+
MAXIMUM LEVEL
ATTACK POWER
DEFENSE POWER
PHYSICAL STRENGTH
MYSTERY CARD
FIRST STATE
SECOND STATE
STATE

### FIG. 6

OWNED CARD INFORMATION: PLAYER A
OWNED CARD ID
LEVEL
ATTACK POWER
DEFENSE POWER
PHYSICAL STRENGTH
MYSTERY CARD
STATE
FIRST STATE
SECOND STATE
NUMBER OF TRANSFERS

### FIG. 7

(S101) READ PLAYER INFORMATION
(S102) IS PREDETERMINED REQUIREMENT SATISFIED?
(S103) UPDATE PLAYER INFORMATION

### FIG. 8

PREDETERMINED TRANSFER REQUIREMENT IS SATISFIED
FIRST STATE
NAME: CHARACTER XYZ
ATTACK POWER
DEFENSE POWER
PHYSICAL STRENGTH
RARITY: SUPER RARE
SPECIAL SKILL
CHARACTER DESCRIPTION
A BRAVE WITH A POWERFUL SPECIAL SKILL, . . .
THIS CARD IS A MYSTERY CARD.
A TRUE ABILITY WILL BE RELEASED IF THE TRANSFER REQUIREMENT˜˜IS SATISFIED!!
SECOND STATE
NAME: CHARACTER XYZ
ATTACK POWER
DEFENSE POWER
PHYSICAL STRENGTH
RARITY: SUPER RARE+
SPECIAL SKILL: THUNDERBOLT
CHARACTER DESCRIPTION
A BRAVE WITH A POWERFUL SPECIAL SKILL, . . .
THE TRUE ABILITY OF THE MYSTERY CARD HAS BEEN RELEASED!

### FIG. 9

OWNED CARD INFORMATION: PLAYER A
PLAYER ID
OWNED CARD ID
LEVEL
ATTACK POWER
DEFENSE POWER
PHYSICAL STRENGTH
MYSTERY CARD
STATE
FIRST STATE
SECOND STATE
NUMBER OF TRANSFERS
OWNING HISTORY

### FIG. 10

NAME: CHARACTER XYZ
ATTACK POWER
DEFENSE POWER
PHYSICAL STRENGTH
RARITY: SUPER RARE
SPECIAL SKILL: THUNDERBOLT
CHARACTER DESCRIPTION
OWNING HISTORY
PLAYER B
PLAYER C
PLAYER A
PLAYER D

1. A server device that controls a game played by a player using game media in a game space through a network, the server device comprising:
a storage unit that stores information about the game media owned by the player in the game space and about states of the game media;
a medium transferring unit that transfers the game media from the player owning the game media such that the game media are owned by another player;
a determining unit that determines whether a specific game medium among the game media has satisfied a predetermined transfer requirement; and
a changing unit that changes, when it is determined that the specific game medium has satisfied the predetermined transfer requirement, the specific game medium from a first state to a second state and stores the changed state in the storage unit.

2. The server device according to claim 1, wherein the predetermined transfer requirement is that the specific game medium be transferred a predetermined number of times or more.

3. The server device according to claim 1, wherein the predetermined transfer requirement is that the specific game medium has been owned by a predetermined number or more of players having different player IDs, by transferring the specific game medium.

4. The server device according to claim 1, wherein
the storage unit stores, for each specific game medium, a player having owned the specific game medium, and
a screen displaying, on the specific game medium, a list of the player having owned the specific game medium is created, or a screen displaying a list of the player having owned the specific game medium, together with the specific game medium is created.

5. The server device according to claim 1, wherein the changing unit determines a parameter in the second state of the specific game medium, based on a parameter set for the specific game medium in the first state and a parameter of the player having owned the specific game medium.

6. The server device according to claim 1, wherein
the game media are set with levels, and
when a level of the specific game medium is lower than a predetermined level, even if there is a request from a player owning the specific game medium, the medium transferring unit does not transfer the specific game medium to another player.

7. A non-transitory computer-readable storage medium storing a game program that causes an information processing device to realize a game played by a player using game media in a game space through a network, and that causes the information processing device to realize the functions of:
storing, by a storage unit, information about the game media owned by the player in the game space and about states of the game media;
transferring, by a medium transferring unit, the game media from the player owning the game media such that the game media are owned by another player;
determining, by a determining unit, whether a specific game medium among the game media has satisfied a predetermined transfer requirement; and
when it is determined that the specific game medium has satisfied the predetermined transfer requirement, changing, by a changing unit, the specific game medium from a first state to a second state and storing the changed state in the storage unit.
